(19) United States
(12) Patent Application Publication
(10) Pub. No.: US 2016/0129905 A1
(43) Pub. Date: May 12, 2016

(54) CONTROL SYSTEM FOR HYBRID VEHICLE

(71) Applicant: TOYOTA JIDOSHA KABUSHIKI KAISHA, Aichi (JP)

(72) Inventors: Kenta KUMAZAKI, Toyota-shi (JP); Tooru MATSUBARA, Toyota-shi (JP); Atsushi TABATA, Okazaki-shi (JP); Tatsuya IMAMURA, Okazaki-shi (JP); Takeshi KITAHATA, Toyota-shi (JP); Yasuhiro HIASA, Nagoya-shi (JP); Munehiro KATSUMATA, Toyota-shi (JP); Kazuyuki SHIIBA, Miyoshi-shi (JP)

(73) Assignee: TOYOTA JIDOSHA KABUSHIKI KAISHA, Toyota-shi, Aichi (JP)

(21) Appl. No.: 14/896,820

(22) PCT Filed: Aug. 2, 2013
(86) PCT No.: PCT/JP2013/071073

§ 371 Date: Dec. 8, 2015

(30) Foreign Application Priority Data
Jul. 11, 2013 (JP) 2013-145291

(51) Int. Cl. B60W 20/40; B60K 6/445; B60K 6/387; B60K 6/26; B60W 10/02; B60W 10/08; B60K 6/365

(52) U.S. Cl. CPC B60W 20/40; B60W 10/08; B60K 6/445; B60K 6/365; B60K 6/26; B60W 10/02; B60K 6/387; B60W 2710/083; F16H 2037/0866

(57) ABSTRACT

A control system for a hybrid vehicle is provided. The hybrid vehicle includes: a power distribution device having a rotary element connected to an engine, a rotary element connected to a first motor, and a rotary element connected to an output shaft; a second motor that applies a torque to the output shaft; and a halting means that halts an output shaft of the engine. The control system is configured to shift from the first mode in which the vehicle is powered by both the first and the second motors to the second mode in which the vehicle is powered only by the second motor while allowing the output shaft of the engine to rotate by the halting device after reducing an output torque of the first motor to a predetermined value.

### TECHNICAL FIELD

The present invention relates generally to a powertrain in which a prime mover includes an engine and a motor, and especially to a control system for a hybrid vehicle to shift an operating mode between a hybrid mode in which the vehicle is powered by both the engine and the motor and a motor mode in which the vehicle is powered only by the motor.

### BACKGROUND ART

A hybrid vehicle having an engine and a motor can be powered not only by the engine and the motor but also only by the motor. In the conventional hybrid vehicles, specifically, one of the motors is driven an engine torque to serve as a generator, and the other motor is activated to generate a drive torque by an electric power delivered from a battery. In the motor mode, the hybrid vehicle thus structured may be powered not only by both motors but also by any one of the motors.

Japanese Patent Laid-Open No. 2010-36880 describes a driving apparatus of a hybrid vehicle in which a prime mover includes an engine and a plurality of motors. According to the teachings of Japanese Patent Laid-Open No. 2010-36880, the driving apparatus is provided with a single-pinion planetary gear unit. In the planetary gear unit, a carrier is connected to an output shaft of the engine, a sun gear is connected to a first motor, and a ring gear is connected to drive wheels through a gear train so that torque of a second motor is delivered to the drive wheels from the ring gear. That is, in the vehicle taught by Japanese Patent Laid-Open No. 2010-36880, the carrier serves as an input element and the sun gear serves as a reaction element during propelling the vehicle by the engine and the motor. In this situation, the first motor is controlled in such a manner to establish a reaction force against the planetary gear unit. The vehicle taught by Japanese Patent Laid-Open No. 2010-36880 may be powered not only by both first and second motors but also only by one of the motors while stopping the engine. In order to stop a rotation of the carrier during propulsion of the vehicle under such motor mode, the driving apparatus is provided with a brake. According to the teachings of Japanese Patent Laid-Open No. 2010-36880, the brake is brought into disengagement during propelling the vehicle only by the second motor. Specifically, the brake is brought into disengagement when the operating mode is shifted from a dual-motor mode in which the vehicle is powered by both of the first and the second motors to a single-motor mode in which the vehicle is powered only by the second motor.

In the driving apparatus taught by Japanese Patent Laid-Open No. 2010-36880, the brake is applied to prevent an inverse rotation of the engine during propelling the vehicle by both of the first and the second motors. However, if the brake is brought into disengagement while generating torque by the first motor when shifting the operating mode from the dual-motor mode to the single-motor mode, the engine generating a driving force may be rotated inversely.

### DISCLOSURE OF THE INVENTION

The present invention has been conceived noting the foregoing technical problem, and it is therefore an object of the present invention is to provide a control system for hybrid vehicles configured to prevent an inverse rotation of the engine when shifting the operating mode from a multi-motor mode to a single-motor mode.

The control system according to the preferred example is applied to a hybrid vehicle comprising: a power distribution device that is adapted to perform a differential action among a first rotary element connected to an engine, a second rotary element connected to a first motor, and a third rotary element connected to an output shaft; a second motor that applies a torque to the output shaft; and a halting means that halts a rotation of the first rotary element. In the hybrid vehicle, an operating mode of the vehicle may be shifted at least between: a first mode in which torques of the first motor and the second motor are delivered to the output shaft while halting a rotation of the first rotary element by the halting means; and a second mode in which torque of only one of the first motor and the second motor is delivered to the output shaft while allowing the first rotary element to rotate by the halting means. In order to achieve the above-explained objective, according to the preferred example, the control system is configured to shift from the first mode to the second mode while allowing the first rotary element to rotate by the halting means after reducing an output torque of the first motor to a predetermined value.

Specifically, the predetermined value may be set to be smaller than a total value of an inertia torque of the first motor and a friction torque of the engine.

The hybrid vehicle further comprises a transmission, in which a first stage is established by bringing a first engagement device into engagement while bringing a second engagement device into disengagement, and in which a second stage is established by bringing the first engagement device into disengagement while bringing the second engagement device into engagement. In addition, the halting means includes the first engagement device and the second engagement device, and the second engagement device is brought into disengagement prior to the first engagement device to allow the first rotary element to rotate.

The output torque of the first motor may be reduced at a predetermined rate when shifting from the first mode to the second mode.

Operating regions for selecting the first mode and the second mode may be determined based on a required driving force and a vehicle speed.

The second mode may include an operating mode in which only a torque of the second motor is delivered to the output shaft while stopping a rotation of the first motor.

The power distribution device may include a first planetary gear unit comprising a first sun gear, a first ring gear arranged concentrically with the first sun gear, and a first carrier supporting first pinion gears meshing with the first sun gear and the first ring gear while allowing to rotate and revolve.

The transmission may include a second planetary gear unit comprising a second sun gear, a second ring gear arranged concentrically with the second sun gear, and a second carrier that is connected to the engine and that supports second pinion gears meshing with the second sun gear and the second ring gear while allowing to rotate and revolve. In addition, the first engagement device is adapted to rotate the second sun gear integrally with the second carrier by being brought into engagement, and the second engagement device is adapted to halt a rotation of the second carrier by being brought into engagement.

Thus, according to the preferred example, the engine is connected to the first rotary element of the power distribution device, the first motor is connected to the second rotary element, and the second motor is connected to a member connected to the third rotary element and the output shaft. A rotation of the first rotary element is halted by the halting means. In the hybrid vehicle, therefore, torque of the first motor is delivered to the output shaft by operating the first motor as a motor while halting the first rotary element by the halting means. That is, the hybrid vehicle can be powered by both the first and the second motors. The hybrid vehicle may also be powered only by the second motor by bringing the halting means into disengagement. In this case, a braking force may be applied to the vehicle while regenerating energy the first motor. Thus, the vehicle may be powered any one of the motors. According to the preferred example, the control system is configured to shift from the first mode in which the vehicle is powered by both the first and the second motors to the second mode in which the vehicle is powered by any one of the motors while allowing the first rotary element to rotate by the halting means after reducing an output torque of the first motor to a predetermined value. According to the preferred example, therefore, the first input element can be prevented from being subjected to a torque in an opposite direction of the output torque of the engine 1 when bringing the halting means into engagement. For this reason, an inverse rotation of the engine can be prevented when shifting the operating mode.

The halting means is brought into disengagement upon reduction in the output torque of the first motor to the threshold value as the total value of the inertia torque of the first motor and a friction torque of the engine. According to the preferred example, therefore, an inverse rotation of the engine can be prevent even if the halting means is brought into disengagement before the output torque of the first motor is reduced to “0”. In addition, control response to shift the operating mode can be improved.

As described, in the transmission, the first stage is established by bringing the first engagement device into engagement while bringing the second engagement device into disengagement, and the second stage is established by bringing the first engagement device into disengagement while bringing the second engagement device into engagement. In addition, the first rotary element is halted by bringing the first engagement device and the second engagement device. In the transmission thus structured, specifically, the operating mode is shifted to the second stage by bringing the second engagement device into disengagement before bringing the first engagement device into disengagement. According to the preferred example, therefore, an inverse torque to rotate the engine inversely can be suppressed during shifting the operating mode.

In addition, since the output torque of the first motor is reduced at the predetermined rate, an abrupt drop in the output shaft torque can be prevented.

### BRIEF DESCRIPTION OF THE DRAWINGS

FIG. 1 is a flowchart showing a control example executed by the control system for hybrid vehicles according to the present invention.

FIG. 2 is a schematic illustration showing one example of the powertrain to which the present invention is applied.

FIG. 3 is a table showing engagement states of the clutch and the brake and operating states of the motor-generators under each operating mode of the powertrains shown in FIG. 2.

FIG. 4 is a nomographic diagram showing states of rotary elements of the power distribution device and the transmission unit under the single-motor mode.

FIG. 5 is a nomographic diagram showing states of the rotary elements of the power distribution device and the transmission unit under the dual-motor mode.

FIG. 6 is a nomographic diagram showing states of the rotary elements of the power distribution device and the transmission unit under the engine mode.

FIG. 7 is a block diagram schematically showing an electronic control unit for controlling the engine, the motor-generators, the clutch and the brake.

FIG. 8 is a map defining regions for selecting the operating mode.

FIG. 9 is a diagram explaining a control of the first motor-generator when shifting the operating mode from the dual-motor mode to the single-motor mode.

FIG. 10 is a time chart showing changes in speeds of the engine and the first and the second motor-generators, hydraulic pressures applied to the clutch C0 and the brake B0, and an opening degree θ of an accelerator.

### DETAILED DESCRIPTION OF THE PREFERRED EMBODIMENT(S)

A powertrain of a hybrid vehicle to which the present invention is applied comprises an engine and at least two motors including a motor for controlling a speed and a torque of the engine, and a motor for generating a driving force. For example, a gasoline engine and a gas engine may be used in the hybrid vehicle. In addition, it is preferable to use at least one motor having a generating function (such as the motor-generator), but the other motor is not necessarily to generate an electric power.

In the hybrid vehicle to which the present invention is applied, an operating mode can be selected from a mode in which the vehicle is powered by the engine, and a mode in which the vehicle is powered only by the motor. Specifically, the operating mode for propelling the vehicle by the engine power can be selected from a mode in which the engine power is partially delivered to driving wheels while operating the motor-generator by the remaining power to generate an electric power for operating the other motor, and a mode in which the engine is used to activate a generator to propel the vehicle by the motor activated by an electric power generated by the generator. Meanwhile, the driving mode for propelling the vehicle only by the motor can be selected from a mode in which the vehicle is power by one of the motors, and a mode in which the vehicle is power by both motors.

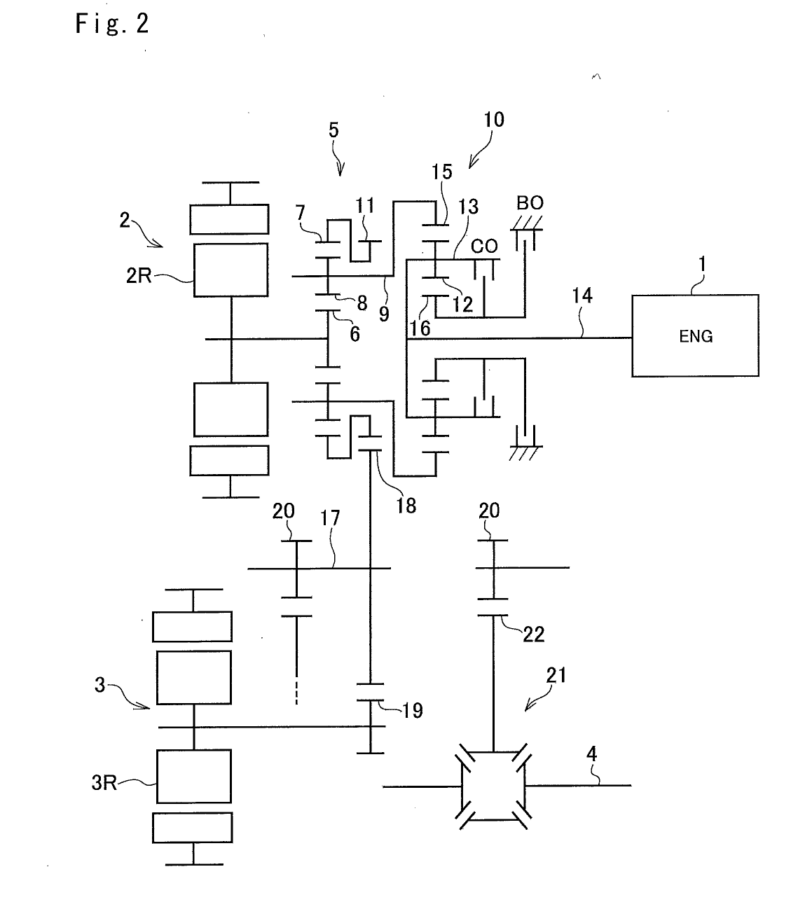

Referring now to FIG. 2, there is shown one example of a powertrain of the hybrid vehicle adapted to select the operating mode from the mode in which the vehicle is powered by the engine, and the mode in which the vehicle is powered only by the motor. In the powertrain shown in FIG. 2, a prime mover includes an engine (ENG) 1 and two motor-generators 2 and 3. That is, the powertrain shown in FIG. 2 is a two-motor type hybrid drive unit. In the powertrain, a power of the engine 1 is distributed to the first motor-generator (MG 1) serving as the claimed first motor and to a drive shaft 4 serving as the claimed output shaft. An electric power generated by the first motor-generator (MG1) is delivered to the second motor-generator (MG2) 3 serving as the claimed second motor to generate a driving force to rotate the drive shaft 4. A single-pinion type planetary gear unit is disposed coaxially with the engine 1 to serve as a power distribution device 5. Specifically, the power distribution device 5 is adapted to perform a differential action among three rotary elements, and a sun gear 6 is connected to a rotor 2R of the first motor-generator 2 disposed in the opposite side of the engine 1 across the power distribution device 5. A ring gear 7 is arranged concentrically with the sun gear 6, and pinion gears 8 interposed between the sun gear 6 and the ring gear 7 while meshing therewith are supported by a carrier 9 while being allowed to rotate and revolve around the sun gear 6. The carrier 9 is connected to an output element of a transmission 10 disposed between the engine 1 and the power distribution device 5, and the ring gear 7 is connected to a drive gear 11 disposed between the transmission 10 and the power distribution device 5. Accordingly, the carrier 9 serves as the claimed first rotary element, the sun gear 6 serves as the claimed second rotary element, and the ring gear 7 serves as the claimed third rotary element.

The transmission 10 shown in FIG. 2 comprises a single-pinion planetary gear unit, and adapted to shift a gear stage between a direct drive stage and a speed increasing stage (i.e., an overdrive stage (O/D) or a high stage). In the transmission 10, a carrier 13 is connected to an output shaft 14 of the engine 1, and a ring gear 15 is connected to the carrier 8 of the power distribution device 5 to be rotated integrally therewith. In this example, a clutch C0 is disposed between a sun gear 16 and the carrier 13 to connect those elements selectively, and a brake B0 is disposed to selectively halt the sun gear 16 arranged concentrically with a ring gear 15. For example, a hydraulically engaged frictional engagement device may be employed as each of the clutch C0 and brake B0. Accordingly, the clutch C0 serves as the claimed first engagement device, and brake B0 serves as the claimed second engagement device. In addition, the direct drive stage established in the transmission 10 corresponds to the claimed first stage, and the speed increasing stage established in the transmission 10 corresponds to the claimed second stage.

A counter shaft 17 is arranged parallel to a common rotational center axis of the power distribution device 5 and the first motor-generator 2, and a counter driven gear 18 meshing with the drive gear 11 is fitted onto the counter shaft 17 to be rotated integrally therewith. A diameter of the counter driven gear 18 is larger than that of the drive gear 11 so that a rotational speed is reduced, that is, torque is multiplied during transmitting the torque from the power distribution device 5 to the counter shaft 17.

The second motor-generator 3 is arranged parallel to the counter shaft 17 so that torque thereof may be added to the torque transmitted from the power distribution device 5 to the driving wheels 4. To this end, a reduction gear 19 connected with a rotor 3R of the second motor-generator 3 is meshed with the counter driven gear 12. A diameter of the reduction gear 19 is smaller than that of the counter driven gear 18 so that the torque of the second motor-generator 3 is transmitted to the counter driven gear 18 or the counter shaft 13 while being amplified.

In addition, a counter drive gear 20 is fitted onto the counter shaft 17 in such a manner to be rotated integrally therewith, and the counter drive gear 20 is meshed with a ring gear 22 of a differential gear unit 21 serving as a final reduction device. In FIG. 2, however, a position of the differential gear unit 21 is displaced to the right side for the convenience of illustration.

In the power train shown in FIG. 2, each motor-generator 2 and 3 is connected individually with an electric storage device such as a battery through a not shown controller such as an inverter. Therefore, those motor-generators 2 and 3 are individually switched between a motor and a generator by controlling a current applied thereto. Meanwhile, an ignition timing of the engine 1 and an opening degree of the throttle valve are controlled electrically, and the engine 1 is stopped and restarted automatically.

In the vehicle having the powertrain thus structured, an operating mode is selected from engine mode where the vehicle is propelled by a power of the engine 1, dual-motor mode where the vehicle is propelled by operating both of the motor-generators 2 and 3 as motors, and single-motor mode where the vehicle is propelled by a power of any one of motor-generators 2 and 3. Specifically, the operating mode can be selected by manipulating the clutch C0 and the brake B0 while controlling output torques of the motor-generators 2 and 3. The single-motor mode corresponds to the claimed first operating mode, and the dual-motor mode corresponds to the claimed second operating mode.

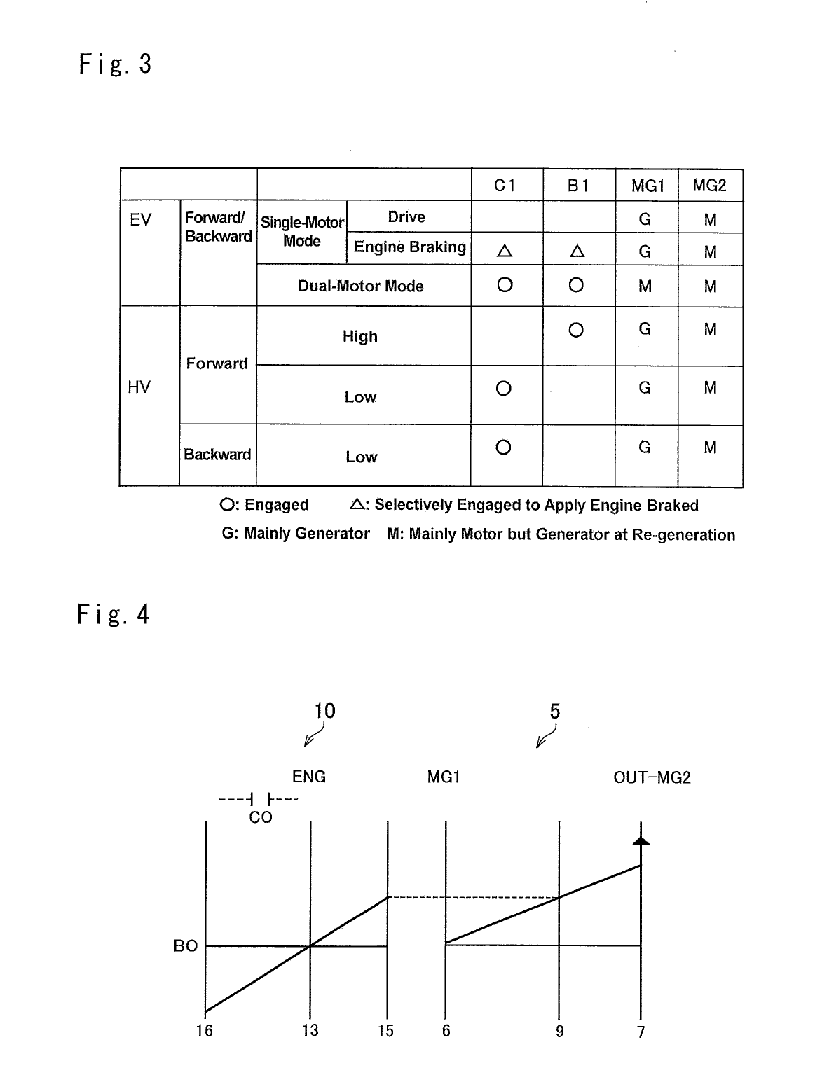

Here will be explained statuses of the clutch C0, the brake B0 and the motor generators 2 and 3 under each driving mode with reference to FIG. 3. In FIG. 3, “EV” represents the mode in which the vehicle is propelled while stopping the engine 1. As can be seen from FIG. 3, during propelling or braking the vehicle under the single-motor mode, both of the clutch C0 and the brake B0 are brought into disengagement. That is, the transmission 10 is brought into a neutral stage to interrupt a torque transmission between the engine 1 and the power distribution device 5. In this situation, a braking force may be applied to the driving wheels by operating the first motor-generator 2 as a generator as indicated by “G” in FIG. 3. By contrast, the second motor-generator 3 is operated as a motor during rotating the driving wheels by the driving force as indicated by “M” in FIG. 3. Thus, the single-motor mode is established by bringing both of the clutch C0 and the brake B0 into disengagement while operating the first motor-generator 2 as a generator or operating the second motor-generator 3 as a motor. Here, the second motor-generator 3 may also be operated as a generator to establish a braking force.

Turning to FIG. 4, there are shown rotational speeds of the rotary elements of the transmission 10 and the power distribution device 5 under the single-motor mode. In FIG. 4, rotational speeds of the rotary elements of the transmission 10 are indicated in the left segment, and rotational speeds of the rotary elements of the power distribution device 5 are indicated in the right segment. Since both of the clutch C0 and the brake B0 are brought into disengagement under the single-motor mode, the transmission 10 is brought into the neutral stage. In this situation, the ring gear 15 as the output element of the transmission 10 that is connected to the carrier 9 of the power distribution device 5 is rotated by the power delivered from the power distribution device 5. Since an inertial force (or an inertial mass) of the engine 1 and a friction torque are greater than an inertial force (or an inertial mass) of a member connected to the sun gear 16, the engine 1 is stopped and the sun gear 16 is idled.

Under the condition that the transmission 10 is thus brought into the neutral stage, the vehicle is powered by the second motor-generator 3 serving as a motor. In this situation, the first motor-generator 2 may be idled. Alternatively, a rotational speed of the first motor-generator 2 may be maintained to a predetermined speed to serve as a generator. To this end, for example, a rotation of the first motor-generator 2 may be stopped by supplying a current to the first motor-generator 2 (i.e., by a d-shaft locking control). In this situation, a braking force may be established by operating the second motor-generator 3 as a generator. In this case, since the transmission 10 is brought into the neutral stage to interrupt torque transmission between the engine 1 and the power distribution device 5, a torque drop resulting from a pumping loss of the engine 1 can be prevented so that a regeneration efficiency can be improved under the single-motor mode. The regeneration efficiency can be further improved by stopping a rotation of the first motor-generator 2 to prevent a passive rotation of the first motor-generator 2. Here, the vehicle can be propelled backwardly by reversing a rotational direction of the second motor-generator 3 to generate an inverse torque.

A capacity of the battery is limited. Therefore, in order to prevent overcharging of the battery, any one of the clutch C0 and the brake B0 are brought into engagement if a state of charge (abbreviated as SOC) of the battery is higher than a predetermined level during applying a braking force to the vehicle under the single-motor mode. To this end, specifically, the engine 1 is connected to the power distribution device 5 to enable torque transmission therebetween thereby establishing an engine braking force. In this case, given that the clutch C0 is brought into engagement, the transmission 10 is brought into the direct drive stage where a sped ratio is larger than that of a case in which the brake B0 is brought into engagement. Therefore, the clutch C0 is brought into engagement if a large braking force is required, and the brake B0 is brought into engagement if a required braking force is relatively small.

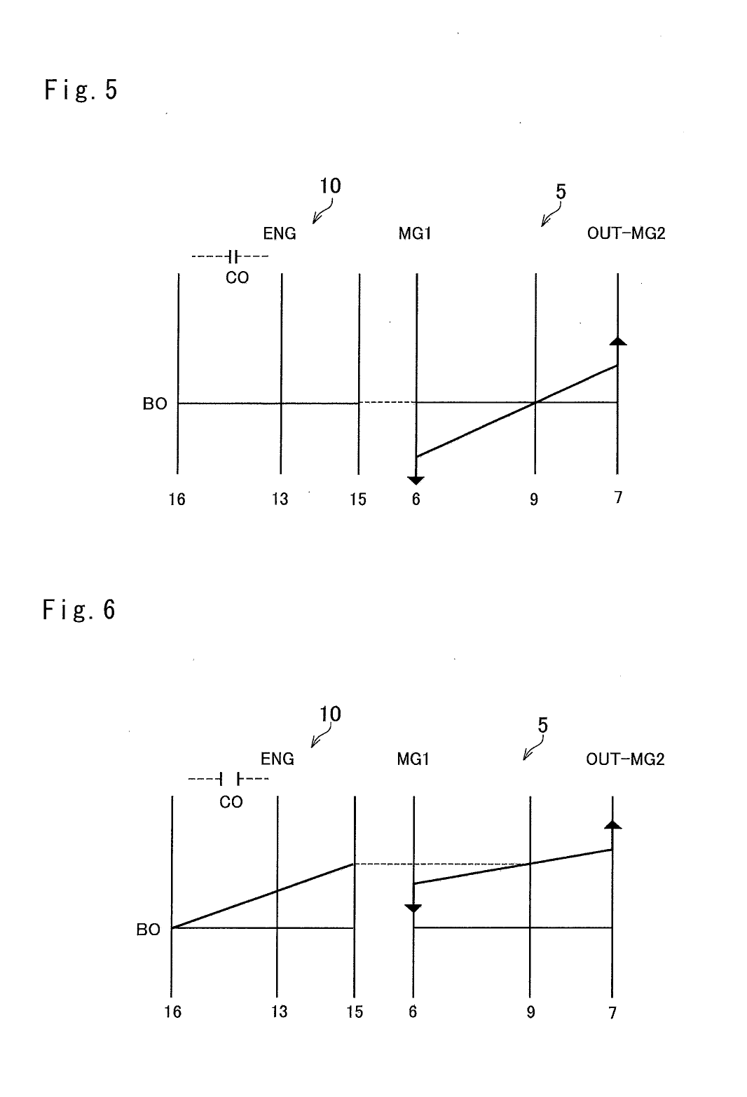

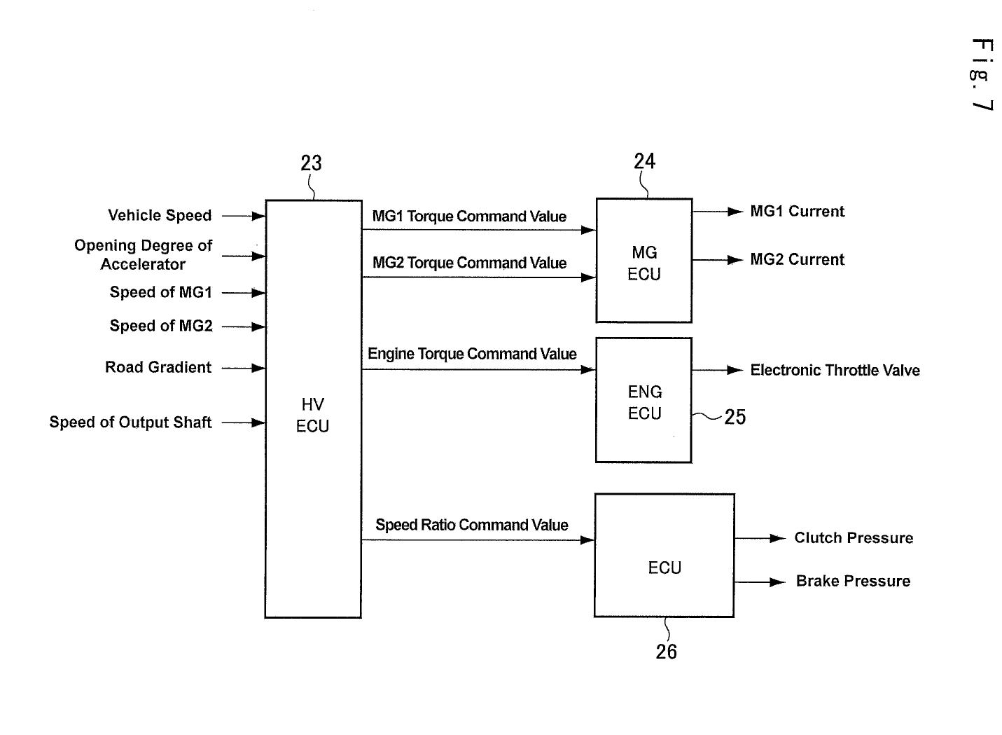

As descried, both of the motor-generators 2 and 3 are used to propel the vehicle under the dual-motor mode. Therefore, the dual-motor mode is selected when a required torque is comparatively large, and both of the motor-generators 2 and 3 are operated as motors. In this case, a rotation of the carrier 9 of the power distribution device 5 is stopped to deliver the drive force generated by the first motor-generator 2. Specifically, in order to stop a rotation of the transmission 10 connected with the carrier 9, both of the clutch C1 and the brake B1 are brought into engagement. Consequently, as indicated in the nomographic diagram shown in FIG. 5, torque of the first motor-generator 2 is delivered to the ring gear 7 while being reversed. Accordingly, a means for stopping a rotation of the carrier 9 by bringing the clutch C0 or the brake B0 serves as the claimed halting means. In this situation, the torque of the first motor-generator 2 is outputted from the ring gear 7 while being amplified in accordance with a gear ratio of the power distribution device 5. Thus, the torque opposite to the engine torque is applied to the carrier 9 of the power distribution device 5 while the clutch C0 and the brake B0 are in engagement. Under the dual-motor mode, the vehicle can be propelled backwardly by reversing rotational directions of the first and the second motor-generators 2 and 3 to generate inverse torques. In addition, both motor-generators 2 and 3 can regenerate energy by being rotated in the inverse direction.

In the powertrain shown in FIG. 2, the engine mode is established by bringing the clutch C0 or the brake B0 into engagement depending on a required drive force. Under the engine mode, therefore, the engine 1 is connected with the power distribution device 5 so that the power generated by the engine 1 is delivered to the driving wheels. In this situation, the power of the engine 1 delivered to the power distribution device 5 is partially converted into an electric power. The electric power thus regenerated by the first motor-generator 2 or the electric power stored in the battery is supplied to the second motor-generator 3 to generate a torque, and the torque of the second motor-generator 3 is delivered to the counter driven gear 12. Thus, under the engine mode, the power of the engine is delivered to the driving wheels by operating the first motor-generator 2 as a generator thereby allowing the sun gear 6 of the power distribution device 5 as a reaction element, while assisting the drive torque of the second motor-generator 3. Accordingly, the engine mode also may be called a hybrid mode. Here, in FIG. 3, “HV” represents the engine mode.

A rotational speed of the first motor-generator 2 can be controlled arbitrarily in accordance with a value and a frequency of a current applied thereto so that a rotational speed of the engine 1 can be controlled by controlling the rotational speed of the first motor-generator 2. To this end, specifically, a target power of the engine 1 is determined based on an opening degree of an accelerator, a vehicle speed and so on, and an operating point of the engine 1 is determined based on the target power of the engine 1 and an optimum fuel economy curve. Then, the rotational speed of the first motor-generator 2 is controlled in such a manner that the engine 1 is operated at the operating point thus determined. That is, the power distribution device 5 is allowed to serve as a continuously variable transmission that is controlled electrically.

Provided that the engine speed is controlled as explained above under a condition that the vehicle speed is high, the first motor-generator 2 may be operated as a motor unwillingly. Therefore, in order to prevent the first motor-generator 2 from being operated as a motor, a gear stage of the transmission 10 is shifted to the speed increasing stage when the vehicle speed is increased. That is, if the vehicle speed is low or middle, the direct drive stage is established in the transmission 10 by bringing the clutch C0 into engagement. In contrast, if the vehicle speed is high, the speed increasing stage is established in the transmission 10 by bringing the brake B1 into engagement. Rotational speeds of the rotary elements of the transmission 10 and the power distribution device 5 under the speed increasing stage are shown in FIG. 5. In this case, the vehicle can be propelled in the backward direction by bringing the clutch C0 into engagement to establish the direct drive stage in the transmission 10.

Next, here will be explained an electronic control unit for controlling the clutch C0, the brake B0, the motor-generators 2 and 3 and the engine 1 with reference to the block diagram shown in FIG. 7. The control unit shown in FIG. 7 is comprised of a hybrid control unit (HV-ECU) 23 for entirely controlling a running condition of the vehicle, a motor-generator control unit (MG-ECU) 24 for controlling the motor-generators 2 and 3, an engine control unit (E/G-ECU) 25 for controlling the engine 1, and a transmission control unit (Transmission-ECU) 26 for controlling the clutch C0 and the brake B0. Each control unit 23, 24, 25, and 26 are individually composed mainly of a microcomputer configured to carry out a calculation based on input data and preinstalled data, and to output a calculation result in the form of a command signal. For example, following data is transmitted to the hybrid control unit 23 such as a vehicle speed, an opening degree of the accelerator, a speed of the first motor-generator 2, a speed of the second motor-generator 3, a road gradient detected by an acceleration sensor (G sensor), a speed of the ring gear 7 (i.e., an output shaft speed), a speed of the engine 1, a state of charge (SOC) of the battery and so on. Meanwhile, the hybrid control unit 23 transmits a torque command for the first motor-generator 2, a torque command for the second motor-generator 3, a torque command for the engine 1, a speed ratio command for the transmission 10 and so on.

The torque command for the first motor-generator 2 and the torque command for the second motor-generator 3 are sent to the motor-generator control unit 24, and the motor-generator control unit 24 calculates current commands to be sent individually to the first motor-generator 2 and the second motor-generator 3 using those input data. Meanwhile, the torque command for the engine 1 is sent to the engine control unit 25, and the engine control unit 25 calculates a command to control an opening degree of the electronic throttle valve and a command to control an ignition timing using those input data. The calculated command values are individually sent to the throttle valve and ignition device (not shown). Likewise, speed ratio command for the transmission 10 is sent to the transmission control unit 26, and the transmission control unit 26 calculates a hydraulic commands to be sent to the clutch C0 and the brake B0.

As described, the prime mover includes the engine 1 and the motor-generators 2 and 3, and a power range and output characteristics of each power unit differs from one another. For example, a torque range and a speed range of the engine 1 are widest in those power units, and an energy efficiency thereof is optimized in a higher range. In turn, the first motor generator 2 is used to control a speed of the engine 1 and a crank angle for stopping the engine 1. To this end, the first motor generator 2 is adapted to output large torque in a low speed region. Meanwhile, the second motor-generator 3 is used to apply torque to the drive shaft 4. To this end, the second motor-generator 3 is allowed to be rotated at higher speed than the first motor generator 2, and a maximum torque of the second motor-generator 3 is smaller than that of the first motor generator 2. Therefore, the control system of the present invention is configured to improve the energy efficiency and the fuel economy by efficiently controlling the prime mover such as the engine 1 and the motor-generators 2 and 3. To this end, the operating mode of the vehicle is shifted among the engine mode, the single-motor mode and the dual-motor mode.

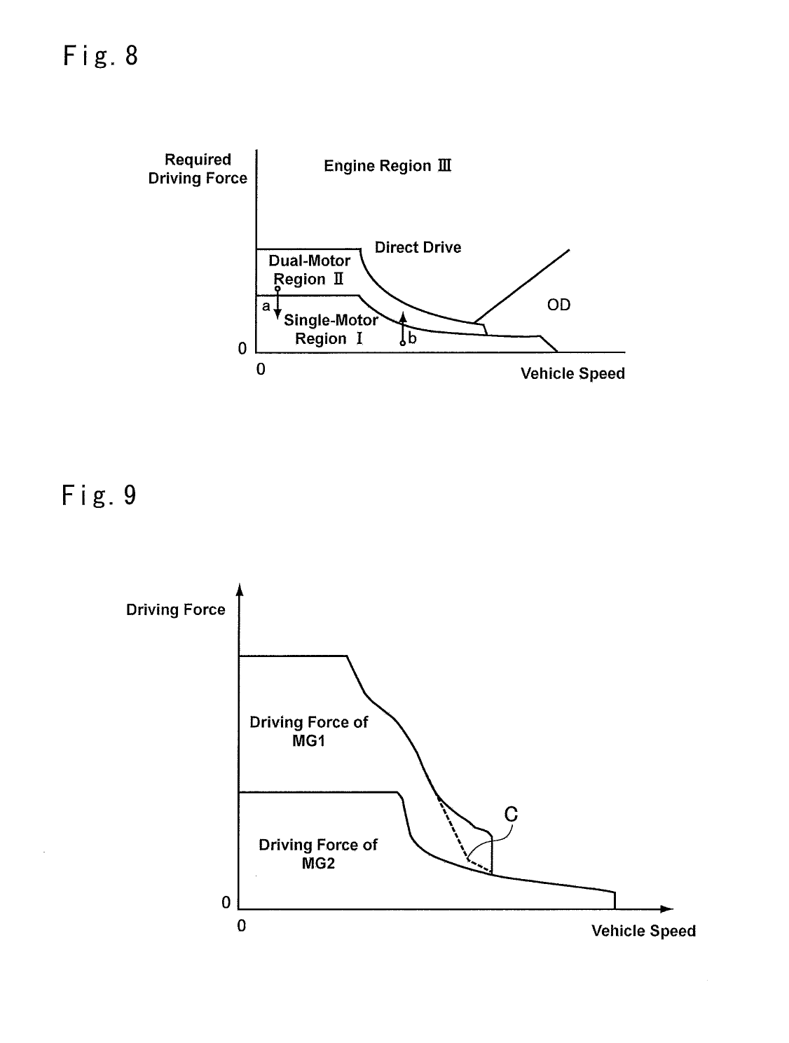

Operating regions of those operating modes are schematically shown in FIG. 8 where a horizontal axis represents a vehicle speed V and a longitudinal axis represents a required driving force F. As can be seen from FIG. 8, the region I represents a single-motor region where the single-motor mode is selected, the region II represents a dual-motor region where the dual-motor mode is selected, and region III represents an engine region where the engine mode is selected. For example, as the case of controlling the engine and the motor-generator(s) in the conventional hybrid vehicle, the required driving force F is calculated based on an opening degree of an accelerator and a vehicle speed. Here, the calculation value of the driving force may be adjusted depending on a grade or a class of the vehicle to achieve a required drive performance and drive characteristics.

According to the preferred example, therefore, the engine mode is selected provided that the opening degree of the accelerator is larger than a predetermined angle, or that the vehicle speed is higher than a predetermined speed. Given that the operating point determined based on the required driving force F and the vehicle speed falls within the engine region, the direct drive stage is established the transmission 10 if the vehicle speed is relatively low, and the speed increasing stage is established in the transmission 10 if the vehicle speed is relatively high. A boundary (OD) between the direct drive stage and the speed increasing stage is drawn in FIG. 8.

By contrast, if the opening degree of the accelerator is small and the required driving force F is therefore small, an operating point of the vehicle falls within the single-motor region I. In this case, the engine 1 is stopped and the clutch C0 and the brake B0 are brought into disengagement to propel the vehicle under the single-motor mode. Then, when the required driving force F is increased and hence the operating point is shifted within the dual-motor region II between the single-motor region I and the engine region III, the engine 1 is also stopped, and the clutch C0 and the brake B0 are brought into engagement to propel the vehicle under the dual-motor mode. Specifically, the single-motor mode and the dual-motor mode are permitted to be selected under the conditions that a state of charge of the battery is sufficient, that the second motor-generator 3 is in condition to generate torque, and that the engine 1 is allowed to be stopped.

During propulsion of the vehicle, the accelerator is operated to address changes in a road gradient, a traffic, a speed limit and so on, and hence a vehicle speed is changed in response to changes in those factors. Consequently, the operating mode of the vehicle is shifted. For example, when an opening degree of the accelerator is reduced during propelling the vehicle under the dual-motor mode, the operating point of the vehicle is shifted from the engine region III to the dual-motor region II or the single-motor region I as indicated by the arrow “a” in FIG. 8. By contrast, when an opening degree of the accelerator is increased, the operating point of the vehicle is shifted from the single-motor region I to the dual-motor region II as indicated by the arrow “b” in FIG. 8. Those shifting operations of the operating mode in response to a change in the operating point are carried out by the aforementioned electronic control unit.

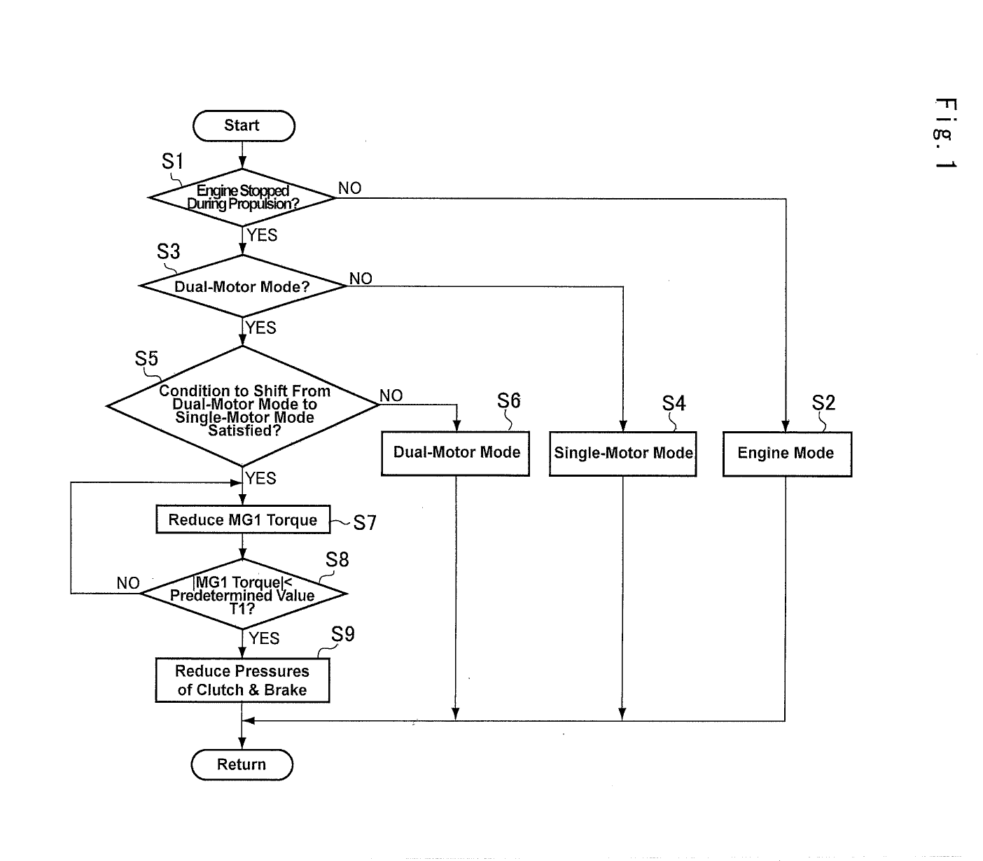

Here will be explained a control example of shifting the operating mode of the powertrain from the dual-motor mode to the single motor-mode with reference to the flowchart shown in FIG. 1. The routine shown in FIG. 1 is repeated at predetermined intervals during propulsion of the vehicle. According to the control example shown in FIG. 1, first of all, it is determined whether or not the vehicle is propelled while stopping the engine 1 (at step S1). That is, it is determined whether or not the operating mode other than the engine mode is selected. Such determination of step S1 can be made based on a transmission of a signals for controlling an electronic throttle valve and an ignition plug from the hybrid control unit 23. If the vehicle is propelled under the engine mode so that the answer of step S1 is NO, the engine mode is continued (at step S2) and the routine is returned.

By contrast, if the vehicle is propelled under the dual-motor mode or the single-motor mode without being powered by the engine 1 so that the answer of step S1 is YES, then it is determined whether or not the vehicle is propelled under the dual-motor mode (at step S3). Such determination of step S3 can be made based on a current supply to each motor-generator 2 and 3, or based on a transmission of signals from the motor-generator control unit 24 to the motor-generators 2 and 3. If the vehicle is currently propelled under the single-motor mode while being powered only by the second motor-generator 3 so that the answer of step S3 is NO, in other words, if a command signal for supplying current to the first motor-generator 2 is not transmitted from the motor-generator control unit 24 and hence the current is not supplied to first motor-generator 2, the single-motor mode is continued (at step S4) and the routine is returned.

By contrast, if the vehicle is propelled under the dual-motor mode so that the answer of step S3 is YES, then it is determined whether or not a condition to shift the operating mode from the dual-motor mode to the single-motor mode is satisfied (at step S5). Specifically, it is determined whether or not the required driving force F or the vehicle speed is decreased and hence the operating point is shifted from the dual-motor region II to the single-motor region I shown in FIG. 8. On this occasion, in order to prevent a frequent shifting of the operating mode resulting from a temporal change of the operating point of the vehicle from the dual-motor region II to the single-motor region I, the condition to shift the operating mode to the single-motor mode is satisfied only if the operating point stays within the single-motor region I longer than a predetermined period of time. If the operating point based on the required driving force F and the vehicle speed falls outside of the dual-motor region II so that the answer of step S5 is NO, the dual-motor mode is continued (at step S6) and the routine is returned.

By contrast, if the operating point is shifted from the dual-motor region II to the single-motor region I as a result of reduction in the required driving force F or the vehicle speed so that the answer of step S5 is YES, an output torque of the first motor-generator 2 is reduced (at step S7). Such reduction in the output torque of the first motor-generator 2 is executed to prevent the carrier 9 from being rotated in a direction opposite to a rotational direction of the engine 1 to generate power by the output toque of the first motor-generator 2 when the clutch C0 or the brake B0 is brought into disengagement while generating torque by the first motor-generator 2. In short, such reduction in the output torque of the first motor-generator 2 is executed to prevent an inverse rotation of the engine 1. In order to prevent abrupt drop in the driving force when reducing the output torque of the first motor-generator 2, it is preferable to reduce the output torque of the first motor-generator 2 along the dashed curve drawn in FIG. 9 showing a control of the first motor-generator 2 to shift the operating mode from the dual-motor mode to the single-motor mode in response to a reduction in the required driving force F. In FIG. 9, the vertical axis represents the driving force, and the horizontal axis represents the vehicle speed.

Then, it is determined whether or not an absolute value of the output torque of the first motor-generator 2 is reduced to be smaller than a predetermined value T1 (at step S8). At step S8, specifically, it is determined whether or not the output torque of the first motor-generator 2 is reduced to a level at which the engine 1 will not be rotated inversely. To this end, the predetermined value T1 is set to a value smaller than a total value of an inertia torque of the first motor-generator 2 and a friction torque of the engine 1. Thus, the predetermined value T1 is set talking account of structures of the first motor-generator 2 and the engine 1. For this reason, the engine 1 can be prevented from being rotated inversely even if the first motor-generator 2 generates torque. In addition, the predetermined value T1 may be a variable that is varied depending on factors influencing a required time to bring the clutch C0 and the brake B0 into disengagement such as a speed of the first motor-generator 2 and an oil temperature in the engine 1. In FIG. 9, the point “C” represents the output torque of the first motor-generator 2 reduced to the predetermined value T1. Accordingly, the predetermined value T1 corresponds to the claimed first predetermined value and the second predetermined value.

If the output torque of the first motor-generator 2 has not yet been reduced to the predetermined value T1, such reduction of the output torque of the first motor-generator 2 and determination of step S8 are repeated until the output torque of the first motor-generator 2 is reduced to the predetermined value T1.

By contrast, if the output torque of the first motor-generator 2 has been reduced to the predetermined value T1 so that the answer of step S8 is YES, hydraulic pressures applied to the clutch C0 and the brake B0 are reduced (at step S9), and the routine is returned. In this case, if the pressure in the brake B0 is reduced slower than the reduction in the pressure in the clutch C0, the gear stage of the transmission 10 is temporarily shifted to the speed increasing stage. Consequently, the torque applied to the engine 1 from the first motor-generator 2 is increased and hence the engine 1 may be rotated inversely. In order to avoid such inverse rotation of the engine 1, it is preferable to reduce the hydraulic pressure in the brake B0 faster than the reduction in the hydraulic pressure in the clutch C0. To this end, specifically, the hydraulic pressure in the clutch C0 is reduced after the lapse of a predetermined period of time ta from a commencement of reduction in the hydraulic pressure in the brake B0. Alternatively, the hydraulic pressure in the clutch C0 may also be reduced after the reduction in the hydraulic pressure in the brake B0 to a level at which the brake B0 is disabled to transmit torque. Optionally, the predetermined period of time ta may be varied in accordance with a temperature of oil delivered to the clutch C0 and the brake B0.

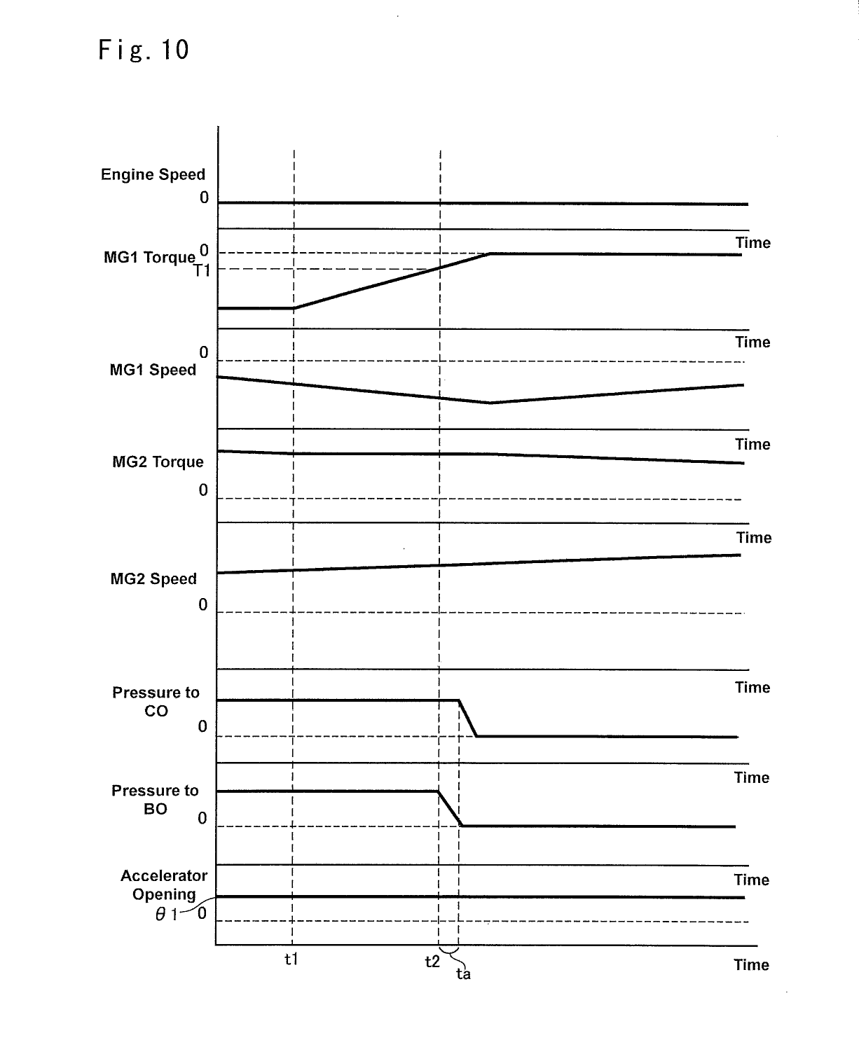

Turning to FIG. 10, there are shown changes in the speeds of the engine 1 and the motor-generators 2 and 3, torques of the motor-generators 2 and 3, hydraulic pressures in the clutch C0 and the brake B0, and an opening degree θ of the accelerator, after the opening degree θ is reduced to a predetermined degree θ1 falling within the single-motor region I. In this situation, the opening degree θ of the accelerator is maintained to the predetermined degree θ1 so that the vehicle speed is increased linearly. Consequently, a rotational speed of the second motor-generator 3 connected to the driving wheels through the gear train is increased linearly.

In this situation, given that the required driving force F is constant, an output torque decreases with an increase in the vehicle speed. In the example shown in FIG. 10, therefore, the output torque of the second motor-generator 3 is reduced while maintaining the output torque of the first motor-generator 2 to a constant level. The situation in which the vehicle speed is thus increased is shown in FIG. 5, and the rotational speed of the first motor-generator 2 is also increased in this situation.

When the predetermined period of time has elapsed since the opening degree θ of the accelerator was reduced to a predetermined degree θ1, the routine shown in FIG. 1 advances from step S5 to S7 so that the operating mode is shifted from the dual-motor mode to the single-motor mode (at point t1). Consequently, the output torque output torque of the first motor-generator 2 is reduced gradually. In this situation, since the opening degree θ of the accelerator is kept to the constant degree, the output torque of the second motor-generator 3 is increased to compensate a reduction in the output torque of the first motor-generator 2. In other words, the output torque of the second motor-generator 3 is increased to be larger than that of the first motor-generator 2 to achieve a required torque of the vehicle determined based on the opening degree θ and the vehicle speed. To this end, according to the example shown in FIG. 10, the output torque of the second motor-generator 3 is kept to a constant level.

When the output torque of the first motor-generator 2 is reduced to the predetermined value T1 at a predetermined rate, the routine shown in FIG. 1 advances from step S8 to S9 so that the hydraulic pressure in the brake B0 is reduced (at point t2) by draining oil from the brake B0 through a control valve. Then, after the lapse of the predetermined period of time to from the commencement of reduction in the hydraulic pressure in the brake B0, the hydraulic pressure in the clutch C0 is commenced. As a result of thus bring the clutch C0 and the brake B0 into disengagement, the transmission 10 and the power distribution device 5 are brought into the neutral state so that the rotational speed of the first motor-generator 2 is changed in accordance with an inertia force of the rotary element connected thereto. In the example shown in FIG. 10, specifically, the rotational speed of the first motor-generator 2 is reduced toward zero.

According to the preferred example, the clutch C0 and the brake B0 are thus brought into disengagement after reducing the output torque of the first motor-generator 2 when shifting from the dual-motor mode to the single-motor mode. For this reason, the engine 1 can be prevented from being rotated inversely by the output torque of the first motor-generator 2. Specifically, the disengagements of the clutch C0 and the brake B0 are started after reducing the output torque of the first motor-generator 2 to the level at which the engine 1 will not be rotated inversely by the output torque of the first motor-generator 2. For this reason, control response to shift the operating mode can be improved in addition to prevent the inverse rotation of the engine 1. More specifically, the brake B0 for establishing the speed increasing stage of the transmission 10 is brought into disengagement prior to bringing the clutch C0 for establishing the direct drive stage of the transmission 10. For this reason, the engine 1 can be prevented from being subjected to a large torque during shifting the operating mode. As a result, an inverse rotation of the engine 1 can be prevented even during shifting the operating mode.

Thus, in the powertrain according to the preferred example, the dual-motor mode is achieved by fixing the rotary element connected to the engine with the power distribution device, and the single-motor mode is achieved by releasing the rotary element from the power distribution device. In the powertrain thus structured, the output shaft of the engine may be connected to one of the rotary elements of the power distribution device, and the output shaft may be halted by a brake. That is, the transmission disposed between the engine and the power distribution device may be omitted. In addition, a double-pinion planetary gear unit may also be used as the power distribution device or the transmission. Further, an electromagnetic clutch and a dog clutch adapted to transmit torque by a force other than a frictional force may be used instead of the clutch activated hydraulically.

1. A control system for a hybrid vehicle,
wherein the hybrid vehicle comprises:
a power distribution device that is adapted to perform a differential action among a first rotary element connected to an engine, a second rotary element connected to a first motor, and a third rotary element connected to an output shaft;
a second motor that applies a torque to the output shaft; and
a halting device that halts a rotation of the first rotary element; and
wherein an operating mode of the vehicle is shifted at least between:
a first mode in which torques of the first motor and the second motor are delivered to the output shaft while halting a rotation of the first rotary element by the halting device; and
a second mode in which torque of only one of the first motor and the second motor is delivered to the output shaft while allowing the first rotary element to rotate by the halting device, and
wherein the control system is configured to shift from the first mode to the second mode while allowing the first rotary element to rotate by the halting device after reducing an output torque of the first motor to a predetermined value.

2. The control system for a hybrid vehicle as claimed in claim 1, wherein the predetermined value is set to be smaller than a total value of an inertia torque of the first motor and a friction torque of the engine.

3. The control system for a hybrid vehicle as claimed in claim 1, further comprising:
a transmission, in which a first stage is established by bringing a first engagement device into engagement while bringing a second engagement device into disengagement, and in which a second stage is established by bringing the first engagement device into disengagement while bringing the second engagement device into engagement;
wherein the halting device includes the first engagement device and the second engagement device; and
wherein the second engagement device is brought into disengagement prior to the first engagement device to allow the first rotary element to rotate.

4. The control system for a hybrid vehicle as claimed in claim 1, wherein the output torque of the first motor is reduced at a predetermined rate when shifting from the first mode to the second mode.

5. The control system for a hybrid vehicle as claimed in claim 1, wherein operating regions for selecting the first mode and the second mode are determined based on a required driving force and a vehicle speed.

6. The control system for a hybrid vehicle as claimed in claim 1, wherein the second mode includes an operating mode in which only a torque of the second motor is delivered to the output shaft while stopping a rotation of the first motor.

7. The control system for a hybrid vehicle as claimed in claim 1, wherein the power distribution device includes a first planetary gear unit comprising a first sun gear, a first ring gear arranged concentrically with the first sun gear, and a first carrier supporting first pinion gears meshing with the first sun gear and the first ring gear while allowing to rotate and revolve.

8. The control system for a hybrid vehicle as claimed in claim 1,
wherein the transmission includes a second planetary gear unit comprising a second sun gear, a second ring gear arranged concentrically with the second sun gear, and a second carrier that is connected to the engine and that supports second pinion gears meshing with the second sun gear and the second ring gear while allowing to rotate and revolve;
wherein the first engagement device is adapted to rotate the second sun gear integrally with the second carrier by being brought into engagement; and
wherein the second engagement device is adapted to halt a rotation of the second carrier by being brought into engagement.
